(19) United States
(12) Patent Application Publication
(10) Pub. No.: US 2015/0338041 A1
(43) Pub. Date: Nov. 26, 2015

(54) LED MODULE WITH LED CHIP GROUPS

(71) Applicant: TRIDONIC JENNERSDORF GMBH, Jennersdorf (AT)

(72) Inventors: Florian WIMMER, Neumarkt a.d. Raab (AT); Juergen GUMHOLD, Jennersdorf (AT)

(21) Appl. No.: 14/654,370

(22) PCT Filed: Dec. 9, 2013
(86) PCT No.: PCT/EP2013/075971

§ 371 Date: Jun. 19, 2015

(30) Foreign Application Priority Data
Dec. 20, 2012 (DE) 10 2012 223 945.6

(51) Int. Cl. F21S 9/02; F21V 23/06; F21K 99/00

(52) U.S. Cl. CPC F21S 9/024; F21K 9/56; F21V 23/06; F21Y 2105/001

(57) ABSTRACT

An LED module, having a carrier, a first group and a second group of LED chips arranged on the carrier, optionally one or more further groups of LED chips, and a layer covering all LED chips and containing at least one color conversion material, which converts the spectrum of the LEDs of one or all groups into a spectrum with a different dominant wavelength. Every group comprises at least one LED chip, preferably a plurality of LED chips. The LED chips of one group are preferably connected in series and can be supplied starting from the same electrical supply. The LED chips of different groups can be supplied independently of one another, starting from different electrical supplies.

The present invention relates to an LED module, an LED luminaire and an emergency light luminaire.

LED modules comprising at least one LED chip are used in many fields of lighting technology. Over recent years, in particular, LED modules have gained a foothold in almost all fields of lighting technology and are increasingly being used on account of their energy efficiency, for example. Since the comparatively low power consumption is positive for use in many fields, LED modules find application for example even if the available electrical power for luminous operation is limited. Emergency light luminaires may serve as an example in this respect, these luminaires being used for lighting in the case of a failure of a power supply system voltage.

A further advantage of the LED modules is that even a relatively large number of LED chips can be fitted onto an LED module with relatively small dimensions. Consequently, a plurality of LED chips can be combined and a higher light power can be realized on a relatively small space.

The present invention addresses the problem, then, of providing LED modules e.g. for use in LED luminaires, and respectively emergency light luminaires, which allows a reduction of the number of LED modules used.

In one embodiment, the invention provides an LED module, comprising a carrier, a first group and a second group of LED chips arranged on the carrier, optionally also one or a plurality of further groups of LED chips, and a layer covering all of the LED chips and containing at least one color conversion substance which converts the spectrum of the LEDs of one or all of the groups into a spectrum having a different dominant wavelength. In this case, each group comprises at least one, preferably a plurality of LED chips. The LED chips of a group are preferably connected in series and are suppliable proceeding from the same electrical supply. The LED chips of different groups are suppliable independently of one another proceeding from different electrical supplies.

The covering layer can be applied above/on the LED chips in particular in a “dam-and-fill” method or by means of a dispensing method, e.g. as ball head or globe-top.

The color conversion substance can contain a phosphor, in particular.

The radiation emitted by the LED chips of the first and second groups can be light in the visible spectrum.

The LED chips of the second group can emit radiation preferably in the red spectrum. The radiation emitted by the LED chips of the second group cannot be converted by the at least one color conversion substance in the covering layer. That is to say that only the spectrum emitted by the first group is converted in this case.

The LED chips of the first and second groups can be substantially identical.

The light power of the second group of LED chips can be in a range of 1%-25%, preferably in a range of 5%-10%, of the light power of the LED chips of the first group. The number of LED chips of the second group can correspond to 1%-25%, preferably 5%-15%, of the number of LED chips of the first group.

The LED module can comprise at least one first conductor for connecting the LED chips of the first group to a first terminal for connecting the first group to a first electrical supply and at least one second conductor for connecting the LED chips of the second group to a second terminal for connecting the second group to a second electrical supply. In this case, the conductors can preferably be arranged on the carrier. The conductors can also lead beyond the actual module carrier and thus be connected e.g. to conductors of other modules. The terminals can likewise be situated outside the LED module carrier, but are preferably arranged on the carrier. The conductors can be at least partly covered by the covering layer.

The conductors can furthermore be arranged at least partly on that side of the carrier on which the LED chips are arranged. However, the conductors can also be arranged at least partly on that side of the carrier on which the LED chips are not arranged.

The terminals on the carrier can be arranged such that they are substantially opposite one another. In particular, the terminals can be arranged on different sides of the LED module. The terminals can also be arranged on different sides of the carrier, e.g. one portion of the terminals can be arranged on that side of the carrier on which the LED chips of a group are situated, while another portion of the terminals is situated on another side of the carrier. The terminals can be arranged substantially parallel to one another. The terminals can be provided on one side of the LED module.

The carrier can be a circuit board, e.g. a single-sided or double-sided PCB, or an SMD carrier (surface mounted device carrier).

In a further aspect, the invention provides an LED luminaire, comprising at least one LED module as described above and a respective independent electrical supply for each group of LED chips.

The electrical supplies of the LED luminaire can be designed as voltage supplies in such a way that only ever one group of LED chips is operated at the same time.

In another aspect, the invention provides an LED-based emergency light luminaire, comprising at least one LED luminaire as described above, wherein at least one group of LED chips can be operated proceeding from a first electrical supply/power supply system voltage and at least one group of LED chips can be operated proceeding from a second electrical supply/power supply system voltage, which is independent of the electrical supply/power supply system voltage. It should be understood that, instead of an electrical supply, a voltage source or current source can in each case be implemented as a basis, wherein one group can be supplied proceeding from a voltage source and another group proceeding from a current source. Moreover, in the case of a plurality of groups, an electrical supply can be provided for each group.

The LED-based emergency light luminaire can furthermore comprise an energy store, preferably a battery or a rechargeable battery, a terminal for connecting the emergency light luminaire to an electrical supply, in particular a supply voltage or power supply system voltage, and an identification circuit designed to identify an interruption of the first electrical supply, wherein the emergency light luminaire is designed to operate at least LED chips of the first group of at least one LED module when the first electrical supply is present, and to operate at least the LED chips of the second group when an interruption of the first electrical supply is identified by the identification circuit.

The emergency light luminaire can operate the second group proceeding from the energy store.

The emergency light luminaire can be designed to operate one LED module as described above and another LED module, wherein the other LED module comprises only one, in particular a single, group of LED chips. The emergency light apparatus can operate the other LED module and/or the LED chips of the first group of the LED module proceeding from the first electrical supply, e.g. when the supply voltage is present. The emergency light luminaire can operate the LED chips of the second group proceeding from the second electrical supply, e.g. in the event of a failure of the supply voltage, and in particular only the second group. The LED chips of the LED module and the LED chips of the other LED module can be arranged identically, preferably in an identical predetermined grid. The LED chips of the modules can substantially correspond or be identical to one another in terms of their number.

In yet another aspect, the invention provides a combination of one LED module as described above with another LED module. The other LED module can comprise only a single group of LED chips, wherein the LED chips of both modules can be arranged in an identical predetermined grid. The LED chips of the modules can substantially correspond or be identical to one another in terms of their number.

The combination can furthermore be combined with a luminaire and/or an emergency light luminaire such as have been described above. In this case, it should be understood that the respective luminaire/emergency light luminaire can also comprise just a single LED module of each type, that is to say can in particular comprise only one LED module as described above.

The invention will now also be described with regard to the figures, in which:

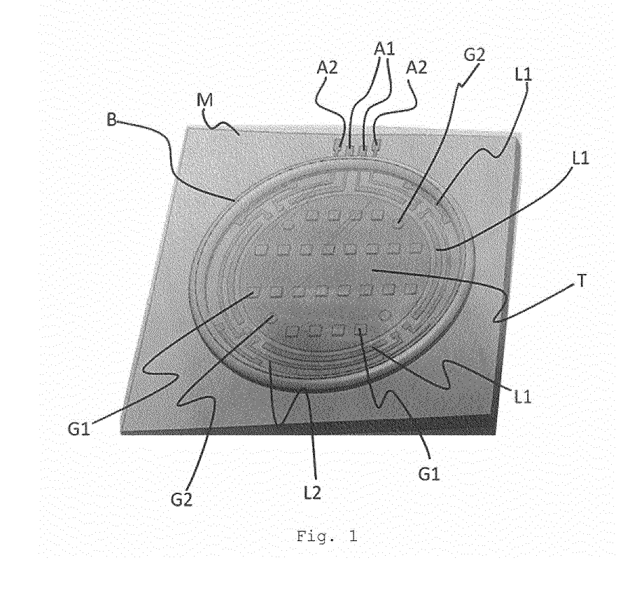

FIG. 1 shows by way of example an LED module according to the invention in accordance with a first embodiment,

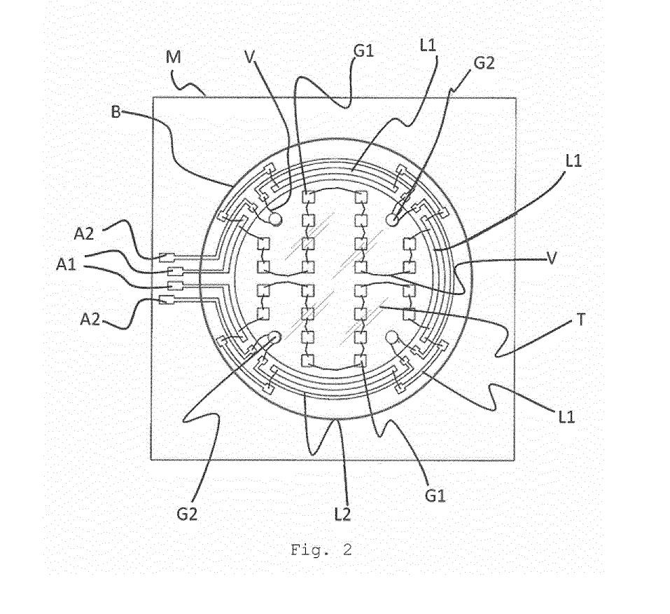

FIG. 2 schematically shows a possible connection of the LED chips to conductors which are fitted on the LED module according to the first embodiment,

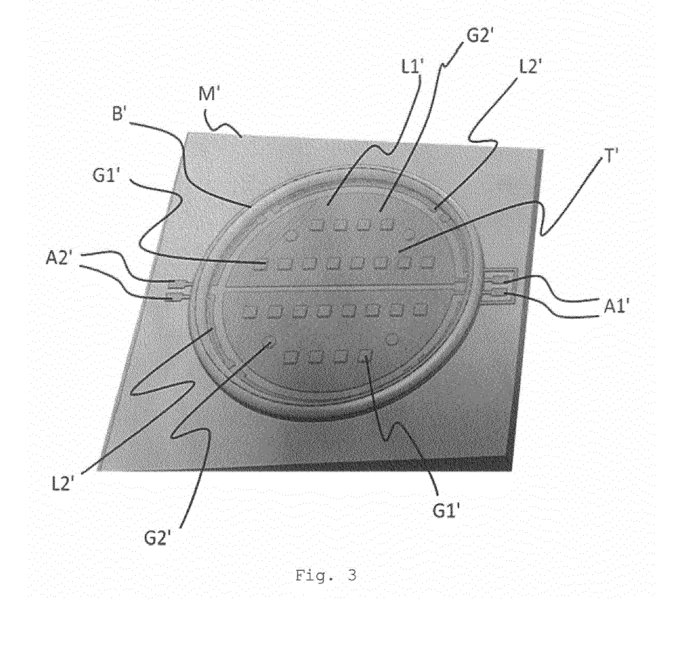

FIG. 3 schematically shows a second embodiment of an LED module according to the invention,

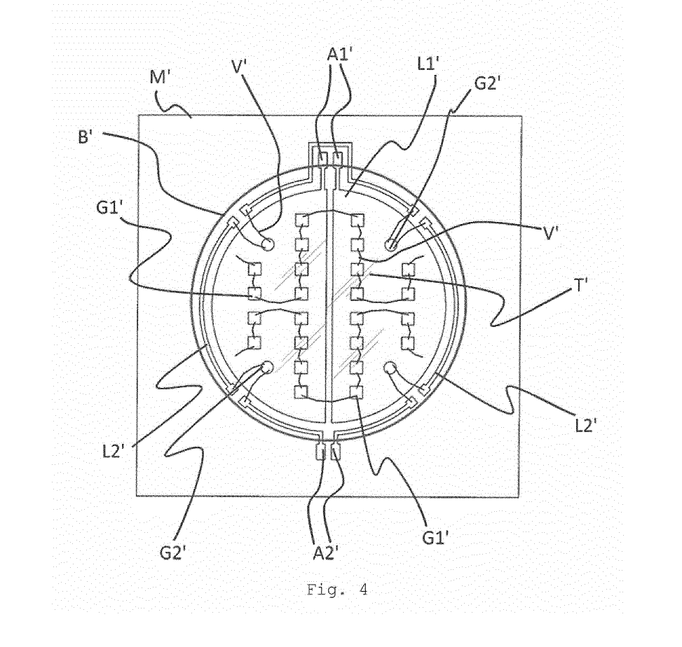

FIG. 4 schematically shows a possible connection of the LED chips to conductors which are fitted on the LED module according to the second embodiment,

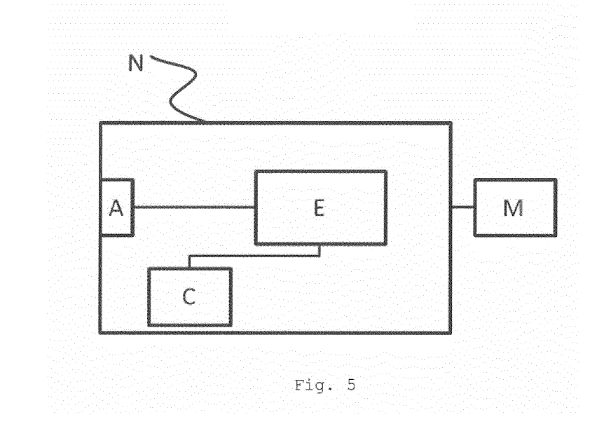

FIG. 5 schematically shows a luminaire, in particular an emergency light luminaire.

The present invention thus relates to LED modules comprising at least two LED chips, wherein the LED chips present on an LED module M, M′ can according to the invention preferably be subdivided into two or more groups G1, G2, G1′, G2′. Overall, the LED module M, M′ is produced by means of known production processes. In this case, it comprises for example a circuit board (e.g. PCB) as carrier or an SMD carrier.

FIG. 1 shows an LED module M of a first embodiment, in which the LED chips of a first group G1 are illustrated as squares and the LED chips of a second group G2 are illustrated as circles. Furthermore, conductors L1, L2 are illustrated, which serve for supplying the respective LED groups G1, G2. A covering layer T is bounded by a barrier B. Terminals A1 are provided for connecting the first group G1 to a first electrical supply, while terminals A2 are provided for connecting the second group G2 to a second electrical supply.

FIG. 2 in this case shows one possibility of how the LED chips of the different groups G1, G2 of the LED module M from FIG. 1 are connected to the respective conductors L1, L2 and thus to the terminals A1, A2 for the respective group G1, G2. In this case, the LED module is illustrated in a manner rotated in the counterclockwise direction by 90° in comparison with FIG. 1. In this case, once again the terminals A1 constitute the terminals for the LED chips for the first group G1, while the terminals A2 constitute the terminals for the second LED chip group G2. The connections between conductors L1, L2 and the LED chips of the groups G1, G2 are designated by V. In particular, the LED chips can be connected in a series circuit. In the example illustrated, the terminals A1, A2 for the LED chip groups G1, G2 are embodied on the same side of the LED module.

In FIG. 3, the terminals A1′ and A2′ of the module M′ are embodied substantially parallel toward a module side. Here, too, two groups G1′, G2′ of LED chips are illustrated, wherein the first LED chip group G1′ is illustrated by way of example by circles and the second group G2′ by squares. Likewise, conductors L1′, L2′ are once again illustrated, which respectively connect an LED group G1′, G2′ to the respective terminals A1′, A2′. In this case, in particular, the conductors L1′, L2′ are shaped differently than in FIG. 1 and the terminals A1′, A2′ are now situated (diametrically) opposite one another on opposite sides of the LED module M′.

FIG. 4 shows how the LED chips of the respective group G1′, G2′ can be connected for example to the terminals A1′ and A2′ of the LED module M′ from FIG. 3 via the conductors L1′ and L2′ and the connections V′. In this case, the LED module is illustrated in a manner rotated in the counterclockwise direction by 90° in comparison with FIG. 3.

In the figures, not all component parts of the same type are provided with reference signs, for the sake of clarity.

FIG. 5 schematically shows a luminaire, in particular an emergency light luminaire N. The emergency light luminaire N is connectable via a terminal A to a first electrical supply, e.g. a supply or power supply system voltage. The emergency light luminaire furthermore comprises an energy store C, which constitutes a second electrical supply. The emergency light luminaire N additionally comprises an identification circuit E, which can identify an interruption of the first electrical supply. The emergency light luminaire N furthermore operates a module M (or M′) which, depending on the state of the first electrical supply identified by the identification circuit E, is supplied either proceeding from the first electrical supply or from the second electrical supply, here e.g. from the energy store C.

In this case, the LED module M, M′ according to the invention is embodied in particular such that each group G1, G2, G1′, G2′ of LED chips can be operated separately proceeding from at least one electrical voltage/current supply. In the figures, the LED chips of a first group G1, G1′ are illustrated schematically as circles, while the LED chips of a second group G2, G2′ are illustrated as squares.

It should be understood, however, that the LED chips need not actually differ in their structural design, or can have other shapes. In particular, cost-effective SMD LED chips can be used as LED chips.

In this case, the LED modules M, M′ according to the invention comprise a first group G1, G1′ of LED chips and a second group G2, G2′ of LED chips, which are arranged under a uniform covering layer T, T′, for example a uniform potting compound. In this case, the covering layer T, T′ comprises in particular a color conversion substance, for example at least one phosphor, which at least partly converts the radiation emitted by the LED chips. In this case, provision can be made for the color conversion substance to convert the radiation emitted by the LED chips of one or a plurality of groups G1, G2, G1′, G2′, e.g. the radiation emitted by all of the groups G1, G2, G1′, G2′, into a radiation that is in a different spectrum than the radiation emitted by the LED chips. Furthermore, provision can be made for the color conversion substance to consist of a plurality of constituents, e.g. a plurality of phosphors. In particular, the color conversion substance converts the radiation of all the LED chips covered by the covering layer T, T′.

Provision can be made for a first group G1, G1′ of LED chips to be operated only if another group G2, G2′ of LED chips is not operated. This is possible in particular by virtue of the fact that the different groups G1, G2, G1′, G2′ of associated LED chips can be supplied from independent electrical supplies. In this regard, it is possible, for example, to supply one LED chip group proceeding from a first electrical supply, e.g. AC voltage/current source, and another LED chip group proceeding from a second electrical supply, e.g. a DC voltage/current source.

Preferably, the in particular two groups G1, G2, G1′, G2′ of LED chips emit radiation in a spectrum, in particular a single spectrum, that is then partly or completely converted by the color conversion substance contained in the covering layer T, T′. It goes without saying that provision can be made for the emitted radiation, e.g. in the visible spectrum, of each LED chip to be converted by the color conversion substance. However, it is also possible for the color conversion substance to convert only the radiation of a group G1, G1′/G2, G2′ or of specific LED chips.

In this case, conversion by the color conversion substance should be understood to mean, in particular, the conversion of radiation having one dominant wavelength into the radiation having another dominant wavelength.

The covering layer T, T′ can be applied above/on the LED chips by means of known methods. By way of example, the covering layer can be applied above/on the LED chips in a “dam-and-fill” method or by means of “dispensing” e.g. as ball head/globe-tops.

In this case, a “dam-and-fill” method should be understood to mean a method in which a barrier B, B′, in particular on the LED module M, M′ is shaped around the LED chips, which barrier prevents an applied covering layer, or a potting compound, from flowing away beyond the barrier B, B′.

The LED module M, M′ designed in this way can then be used in particular in LED luminaires which are supplied via independent electrical supplies for each LED chip group G1, G2, G1′, G2′. In this regard, two different illumination modes can be set with a single LED module M, M′.

This is advantageous for example in situations in which light in one spectrum is intended to be emitted in one specific situation, while light in another spectrum is intended to be emitted in another situation. Moreover, the light power emitted by the LED module M, M′ can be varied by the targeted driving of different groups G1, G2, G1′, G2′. In this regard, it is e.g. conceivable for the LED modules M, M′ according to the invention to be used in vehicles, for example aircraft or trains, in which, for example, reading lighting or resting lighting is intended to be provided at a seat. In this case, a relatively large number of LED chips can be subdivided in a first group G1, G1′, which is driven for the normal lighting, while a smaller number of LED chips relative thereto can be subdivided in a second group G2, G2′, which is then driven selectively if resting operation/reading lighting operation is intended to be provided, for example in response to interaction of a user.

Furthermore, use in an emergency light luminaire N is also suitable (see FIG. 5), said emergency light luminaire changing from normal operation to emergency light operation for example in the event of a failure of a power supply system voltage. The production costs can be lowered here by the LED module M, M′ according to the invention since now only one type of LED module need be installed. The emergency light luminaire N can thus drive a first group G1, G1′ of LED chips of the LED module M, M′ in normal light operation, while a second LED chip group G2, G2′ of the same module M, M′ is driven in emergency light operation. By way of example, therefore, in emergency light operation, the second group G2, G2′ of LED chips can be supplied preferably with a DC voltage proceeding from an energy store C (for example a battery and/or a rechargeable battery) in emergency light operation. In normal light operation, the LED module is supplied with a supply voltage, in particular a power supply system/AC voltage, proceeding from a terminal A.

In this case, the light power of the second LED chip group G2, G2′, e.g. of an emergency light LED chip group, can be preferably in a range of 1% to 25%, more preferably in a range of 5% to 10%, of the light power of the first LED chip group G1, G1′, e.g. of a normal light LED chip group.

Overall, the LED chips of the LED module M, M′ can be distributed among different groups. Preferably, however, a reduction of the emitted light power can be achieved by more LED chips being subdivided in one group than in another LED group. In the case of two groups G1, G2, G1′, G2′, for example, a reduction of the light power is achieved by virtue of the fact that although the LED chips of both groups G1, G2, G1′, G2′ are substantially identical, i.e. emit at least in the same color, or in the same spectrum, the number of LED chips in the first group G1, G1′ is only 1% to 25%, or preferably 5% to 15%, of the number of LED chips of the second group G2, G2′. As a result, for example, the reduction of the light power to the emergency light operation power can also be realized by a changeover being made in emergency light operation from the first group G1, G1′ to the second group G2, G2′ of LED chips and said second group then being operated by the emergency light luminaire N.

As a result, the power consumed by the LED module M, M′ can naturally be reduced, wherein the decrease in the number of LED chips to be operated already contributes to the reduction. A further reduction of the required operating power can be effected by means of the selection of different LED chips for each group. In this regard, by way of example, LED chips having greater energy efficiency than in the first group can be used in the second group.

Overall, it is possible, of course, to provide a plurality of groups and thus to achieve a grading of the emitted light power. By way of example, in the case of three LED groups, firstly the LED chips of all three groups could be operated in normal light operation, while different modes can be selected in order to deactivate/activate individual LED groups. If, in this case, the operation of an LED group is designated by “1” and the switch-off of an LED group is designated by “0”, then in the case of three LED groups there are already eight possible operating modes: 1, 1, 1; 1, 1, 0; 1, 0, 1; 1, 0, 0; 0, 1, 1; 0, 1, 0; 0, 0, 1; and 0, 0, 0.

These operating modes can e.g. also be chosen depending on the available power or as a result of the elapsing of time. In this regard, provision can be made for one operating mode to be chosen if more power can/is intended to be retrieved from an energy store (e.g. the energy store C), while another operating mode is chosen if a specific threshold value is reached. Accordingly, a plurality of threshold values can be provided with regard to which an/the operating mode/modes is/are chosen. Alternatively or additionally, an operating mode can be chosen after a time interval starting from the occurrence of an event, e.g. after identification by the identification circuit E of a failure of a power supply system voltage. In this regard, different operating modes can be chosen at fixed or variable time intervals after the event.

In principle, however, the LED groups G1, G2, G1′, G2′ can also emit in different colors, wherein in accordance with one exemplary embodiment the radiation/light in particular from LED chips of the second LED chip group G2, G2′ can be in a different spectrum, for example in the red spectrum, which is not converted by a color conversion substance used, in particular a phosphor used, in the covering layer T, T′, with respect to the radiation emitted by the LED chips of the first group G1, G1′.

It goes without saying that the LED module M, M′ according to the invention can be used and arranged individually but also in combination with other LED modules. What is of interest in this case is, in particular, the combination of the LED module M, M′ according to the invention with an LED module comprising overall the same number of LED chips in an identical arrangement, for example in an identical grid. This is expedient particularly if in a first operating mode, e.g. a normal light mode, a plurality of LED modules are intended to emit an identical light power, while in another operating mode, e.g. an emergency light operating mode, only the LED modules M, M′ according to the invention that are designed for this mode or their LED chips of the second group G2, G2′ are intended to be operated. In this case, the energy demand can be greatly reduced particularly for emergency light luminaires N, as a result of which the possible operating duration of the emergency light luminaires N in the emergency light operating mode is greatly lengthened. In particular, the energy store C is then loaded to a lesser extent.

Furthermore, the combination of the LED module M, M′ according to the invention with an emergency light luminaire N is also provided, which can then for example also be combined with further LED modules, in particular having an identical number and identical arrangement of LED chips.

Preferably, the LED modules M, M′ according to the invention are embodied such that in comparison with other LED modules having a plurality of LED chips there is no deviation in the arrangement of the LED chips on the LED module and/or the emitted light power in normal operation.

It should obviously be understood that different conductor routings and terminal arrangements can be provided particularly in the case where a plurality of LED chip groups are present. All that is important here is that each LED group can be supplied via a separate voltage supply.

1. An LED module, comprising:
a carrier,
a first group and a second group of LED chips arranged on the carrier, and
a layer covering all of the LED chips and containing at least one color conversion substance which converts the spectrum of the LEDs of one or all of the groups into a spectrum having a different dominant wavelength,
wherein:
each group comprises at least one, preferably a plurality of LED chips,
the LED chips of a group are preferably connected in series and are suppliable proceeding from the same electrical supply, and
the LED chips of different groups are suppliable independently of one another proceeding from different electrical supplies.

2. The LED module as claimed in claim 1, wherein the covering layer is applied above/on the LED chips in particular in a “dam-and-fill” method or by means of a dispensing method, e.g. as ball head or globe-top.

3. The LED module as claimed in claim 1, wherein the color conversion substance contains a phosphor, in particular.

4. The LED module as claimed in claim 1, wherein the radiation emitted by the LED chips of the first and second groups is light in the visible spectrum.

5. The LED module as claimed in claim 1, wherein the LED chips of the second group emit radiation preferably in the red spectrum, and/or wherein the radiation emitted by the LED chips of the second group is not converted by the at least one color conversion substance in the covering layer.

6. The LED module as claimed in claim 1, wherein the LED chips of the first and second groups are substantially identical.

7. The LED module as claimed in claim 1, wherein the light power of the second group of LED chips is in a range of 1%-25%, preferably in a range of 5%-10%, of the light power of the LED chips of the first group, and/or wherein the number of LED chips of the second group corresponds to 1%-25%, preferably 5%-15%, of the number of LED chips of the first group.

8. The LED module as claimed in claim 1, wherein the LED module comprises at least one first conductor for connecting the LED chips of the first group to one terminal for connecting the first group to a first electrical supply and at least one second conductor for connecting the LED chips of the second group to another terminal for connecting the second group to a second electrical supply, wherein the conductors are arranged on the carrier.

9. The LED module as claimed in claim 1, wherein the conductors are arranged at least partly on that side of the carrier on which the LED chips are arranged, and/or wherein the conductors are arranged at least partly on that side of the carrier on which the LED chips are not arranged.

10. The LED module as claimed in claim 1, wherein the terminals on the carrier are arranged such that they are opposite one another and/or are arranged at least partly substantially parallel to one another, and/or wherein terminals are provided on one module side or mutually opposite module sides.

11. The LED module as claimed in claim 1, wherein the conductors are at least partly not covered by the covering layer.

12. The LED module as claimed in claim 1, wherein the carrier is a circuit board or an SMD carrier.

13. An LED luminaire, comprising at least one LED module as claimed in claim 1, and a respective independent electrical supply for each group of LED chips.

14. The LED luminaire as claimed in claim 13, wherein the electrical supplies are designed as voltage/current supplies in such a way and that only ever one group of LED chips is operated at the same time.

15. An LED-based emergency light luminaire, comprising at least one LED luminaire as claimed in claim 13, wherein at least one group of LED chips is operable proceeding from a first electrical supply and at least one group of LED chips is operable proceeding from a second electrical supply, which is independent of the first electrical supply.

16. The LED-based emergency light luminaire as claimed in claim 15, comprising
an energy store, preferably a battery or a rechargeable battery, a terminal for connecting the emergency light luminaire to a first electrical supply, in particular a power supply system voltage, and an identification circuit designed to identify an interruption of the first electrical supply, wherein the emergency light luminaire is designed to operate at least the LED chips of one group of at least one LED module when the first electrical supply is present, and to operate at least the LED chips of another group when an interruption of the first electrical supply is identified by the identification circuit.

17. The LED-based emergency light luminaire as claimed in claim 15, wherein
the emergency light luminaire operates the other group proceeding from a second electrical supply, in particular proceeding from the energy store.

18. The LED-based emergency light luminaire as claimed in claim 1, wherein the emergency light luminaire is designed to operate one LED module as claimed in claim 1 and another LED module, wherein the other LED module comprises only one group of LED chips, and wherein the emergency light apparatus operates the LED chips of one group of the LED module and/or the other LED module when the first electrical supply is present, and/or only operates the LED chips of the other group in the event of a failure of the first electrical supply, and wherein the LED chips of the LED module and the LED chips of the other LED module are arranged identically, preferably in an identical predetermined grid, and/or wherein the LED chips of the LED modules correspond to one another in terms of their number.

19. The combination of one LED module as claimed in claim 1 with another LED module comprising only a single group of LED chips, wherein the LED chips of both modules are arranged in an identical predetermined grid, and/or substantially correspond to one another in terms of their number.

20. (canceled)
